(19) United States
(12) Patent Application Publication
(10) Pub. No.: US 2015/0233787 A1
(43) Pub. Date: Aug. 20, 2015

(54) AIR GAP CRAWLER INSTALLATION DEVICE

(71) Applicant: ABB Technology AG, Zurich (CH)

(72) Inventors: William Eakins, Bloomfield, CT (US); Gregory Rossano, Enfield, CT (US); George Q. Zhang, Windsor, CT (US); Thomas A. Fuhlbrigge, Ellington, CT (US); Hetal V. Lakhani, Rajkot (IN); Cajetan Pinto, Mumbai (IN); Gregory Penza, Old Field, NY (US); Hermann Herrlich, Lindenhurst, NY (US); Robert Kodadek, Long Beach, NY (US)

(73) Assignee: ABB Technology AG, Zurich (CH)

(21) Appl. No.: 14/623,933

(22) Filed: Feb. 17, 2015

Related U.S. Application Data
(60) Provisional application No. 61/941,538, filed on Feb. 19, 2014.

(51) Int. Cl. G01M 13/00; G01M 15/02

(52) U.S. Cl. CPC G01M 13/00; G01M 15/02; Y10S 901/44; Y10S 901/01

(57) ABSTRACT

A device for installing a modular crawler into an air gap of rotating electrical machinery and removing the crawler from the air gap has a reconfigurable handle attached to a curved head made from metallic material. The crawler is magnetically attached to the curved head when it is desired to insert the crawler into the air gap or remove the crawler from the air gap. The head can be rolled in the field into the curvature needed to match the stator's inner surface so that the installation device can easily be inserted in the air gap. The handle has several joints that can be adjusted in the field as needed for the best reachability. A camera is mounted on the curved head so that an operator can see the interface region between the curved head, crawler and air gap.

### FIELD OF THE INVENTION

The present invention relates to devices known as crawlers or robots for use in the confined space in machinery such as a rotating electrical machine to inspect the air gap in that type of machine and perform other tasks related to such machines and more particularly to the tool that is used to insert and remove the air gap inspection device from the air gap.

### DESCRIPTION OF THE PRIOR ART

Devices known as crawlers or robots are now used to perform some tasks such as air gap inspection in some designs for motors and generators.

### SUMMARY OF THE INVENTION

A vehicle delivery and retrieval device for inserting a remotely controlled vehicle in a confined space in a machine to inspect the confined space has a head dimensioned to fit in the confined space. The head is fabricated to hold the vehicle without movement of the vehicle when the head with the vehicle mounted on the head is inserted in the confined space. The device also has a handle having one end attached to the head by a joint and two or more sections connected to each other by an associated joint.

A method for using a remotely controlled vehicle to inspect a confined space in a machine has the steps of:

mounting the vehicle on a head of a vehicle delivery and retrieval device, the head dimensioned for insertion in the confined space, the vehicle delivery and retrieval device having a handle having one end attached to the head by a joint and two or more sections connected to each other by an associated joint; and

inserting the vehicle delivery and retrieval device with the vehicle on the head in the confined space.

A vehicle delivery and retrieval device for inserting a remotely controlled vehicle in a confined space in a machine to inspect said confined space has a head dimensioned to fit in the confined space. The head is fabricated to hold said vehicle without movement of the vehicle when the head with the vehicle mounted on said head is inserted in the confined space. The device also has a handle that has one end attached to the head.

### DESCRIPTION OF THE DRAWING

FIG. 1 shows a cross section of one example of the rotor, stator and air gap of a rotating electrical machine.

FIG. 2a illustrates generically with the stator in place in the machine a robot crawler crawling on the teeth of the rotor of the machine.

FIG. 2b shows the crawler crawling on the stator teeth without the rotor in place.

FIG. 3 shows one embodiment for the crawler.

FIGS. 4a and 4b both show a top view of one embodiment for the crawler installation device with the crawler not shown in FIG. 4a and shown in FIG. 4b.

FIG. 5a shows a perspective view of the crawler installation device head without the crawler on the head.

FIGS. 5b and 5c show respectively a top view and back view of the crawler installation device.

FIG. 6 shows an embodiment for the crawler installation device that has a handle with four joints.

FIGS. 7 and 8 show other embodiments for the crawler installation device handle.

FIGS. 9a, 9b and 9c show the installing of the crawler in the air gap of a rotating electrical machine using the installation device.

FIG. 10 shows an embodiment of the installation device with a crawler and camera on the head of the device.

FIG. 11 shows the control cabinet with video displays for the crawler.

FIGS. 12 and 13 each show respectively an exploded embodiment for an associated one of the drive modules shown in the exploded perspective for one embodiment for the crawler shown in FIG. 14.

### DETAILED DESCRIPTION

A crawler or robot device one embodiment for which is described below is used in operations such as visual inspection, wedge tapping, stator repair and maintenance such as cleaning inside the air gap between the stator and the rotor of rotating electrical machinery. The rotating machinery can be large size motors and generators and other rotating machines such as gearless mill drives that have the same stator, rotator and air gap setup as that in large size motors and generators.

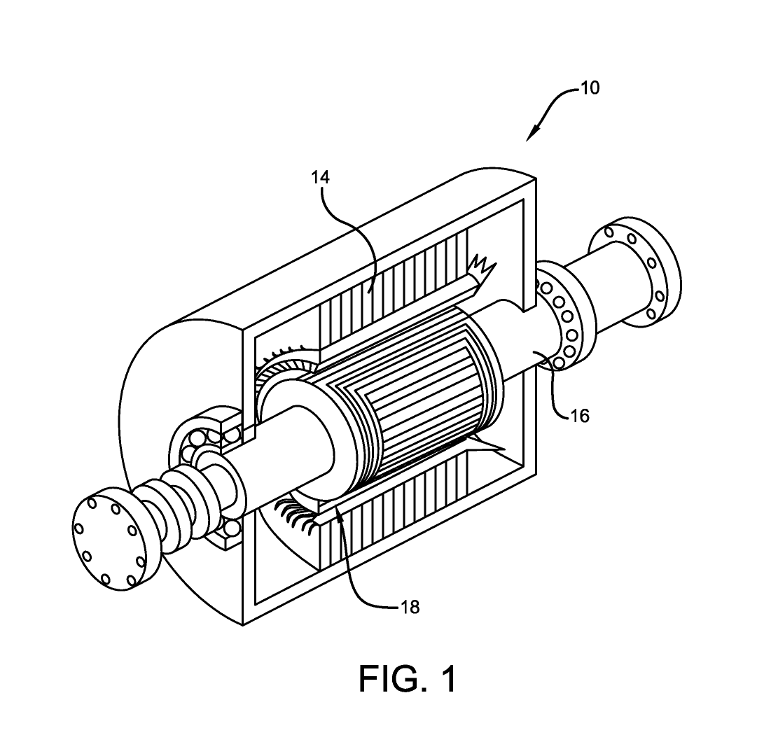

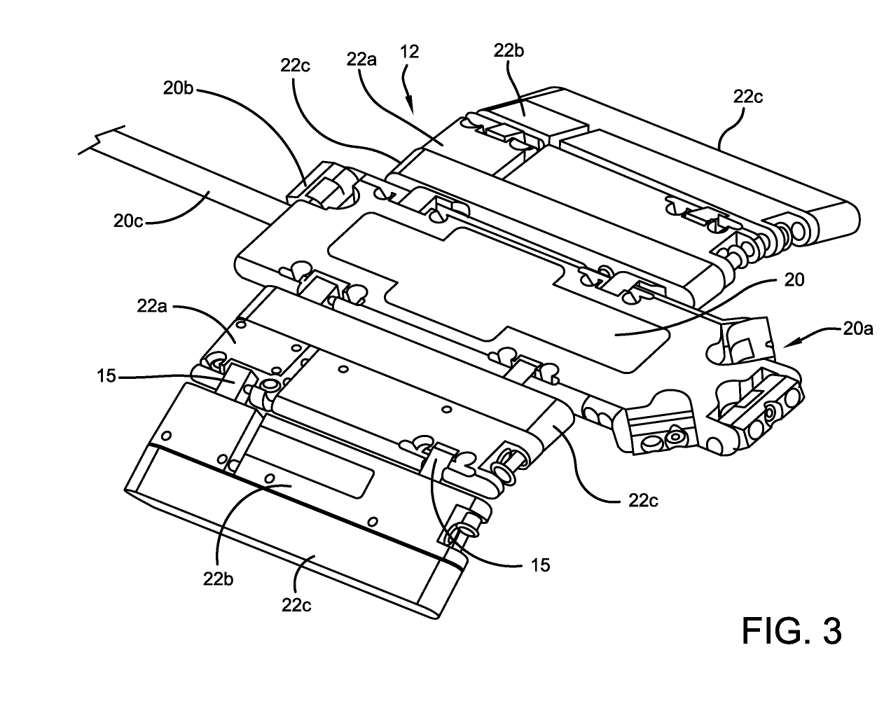

Referring now to FIG. 1, there is shown a cross section of one example of the rotor 16 and stator 14 of a rotating electrical machine 10 in which the present crawler or robot device 12, an embodiment for which is shown in FIG. 3 described below, can be used. The rotating machine in FIG. 1 is a typical motor/generator with stator 14, rotor 16 and air gap 18. The crawler 12 crawls on the stator 14.

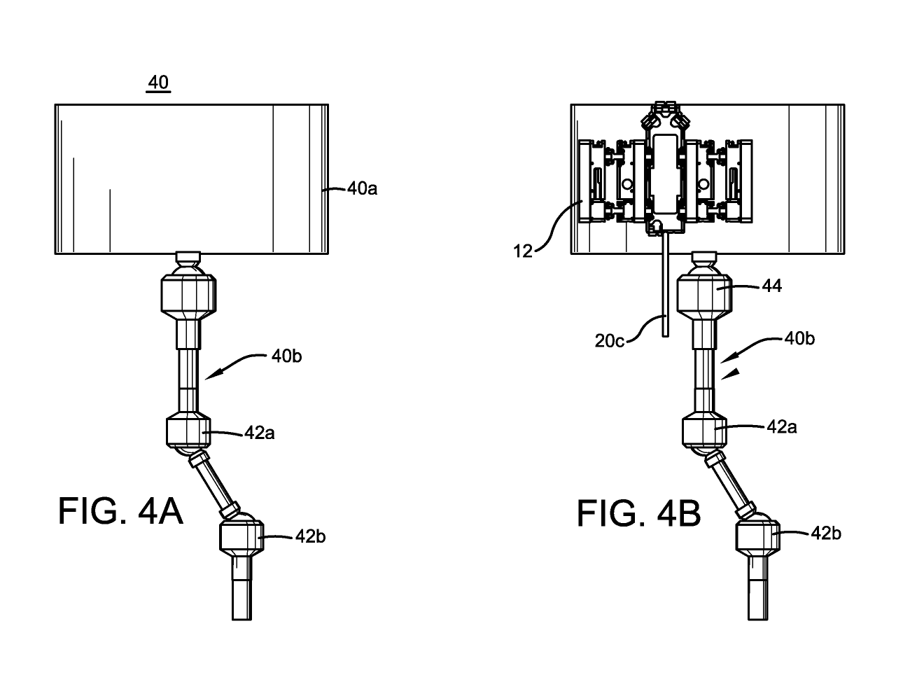

As is shown in FIGS. 3 and 4b, the crawler 12 in this one embodiment has a tethered function module 20 and inner and outer drive modules 22a and 22b respectively that are attached to each other and in combination are attached to the right and left sides of module 20. The crawler 12 may also have untethered function modules 24z which are not shown in FIGS. 3 and 4b.

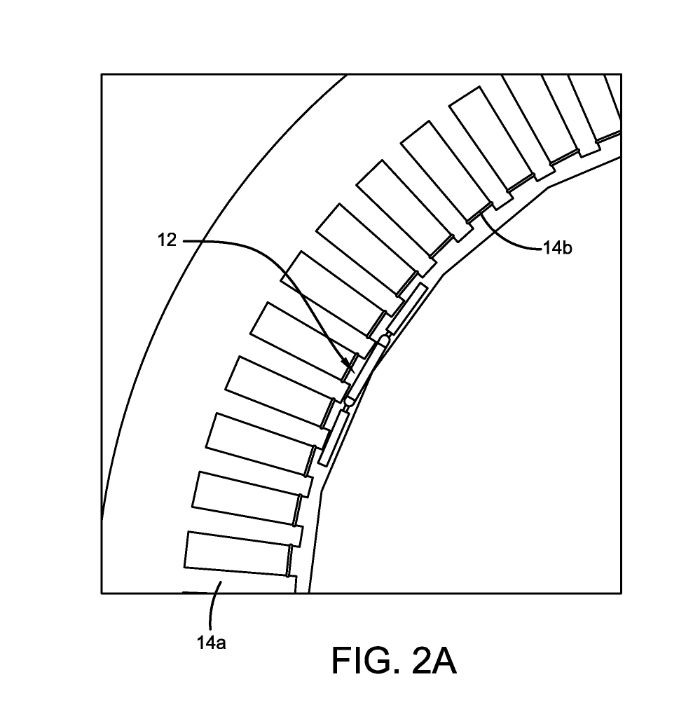

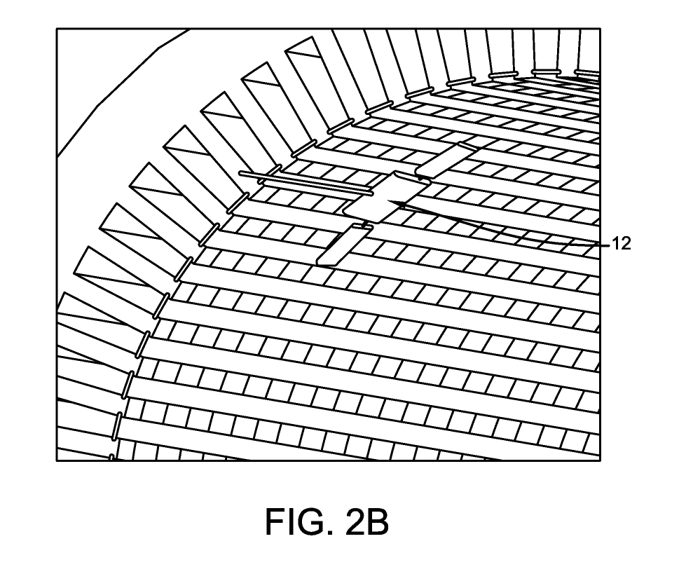

Referring now to FIG. 2a, there is illustrated generically with the rotor 16 in place in machine 10 a robot crawler 12 crawling on the teeth 14a of stator 14 of the machine 10. The teeth 14a are typically laminated steel or another ferromagnetic material. As is well known, the teeth 14a can be of different configurations of slot dimensions and shapes. The diameter of the stator teeth can also vary. FIG. 2b shows the crawler 12 crawling on the stator teeth 14a without the rotor 16 in place. For ease of illustration the copper coils in machine 10 are not shown in FIGS. 2a and 2b.

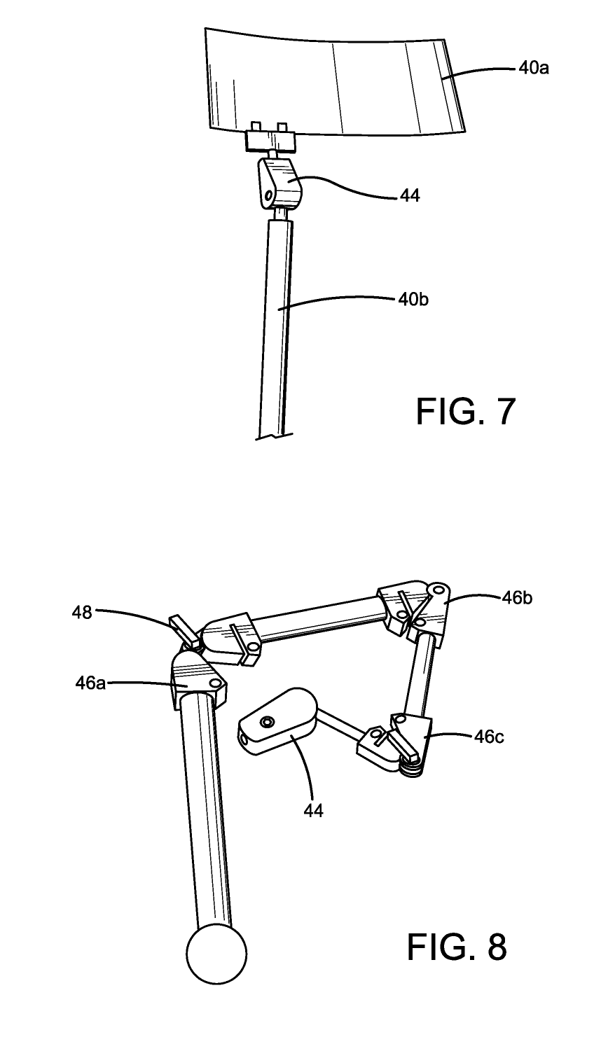

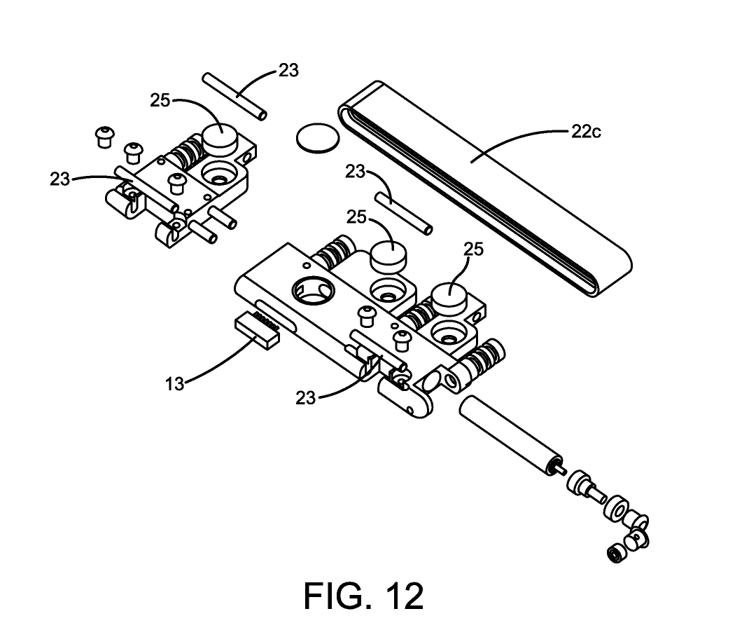

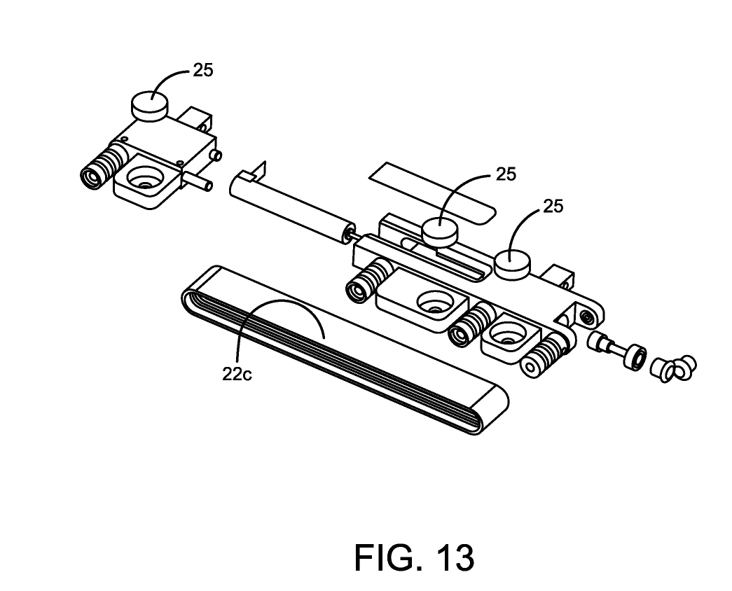

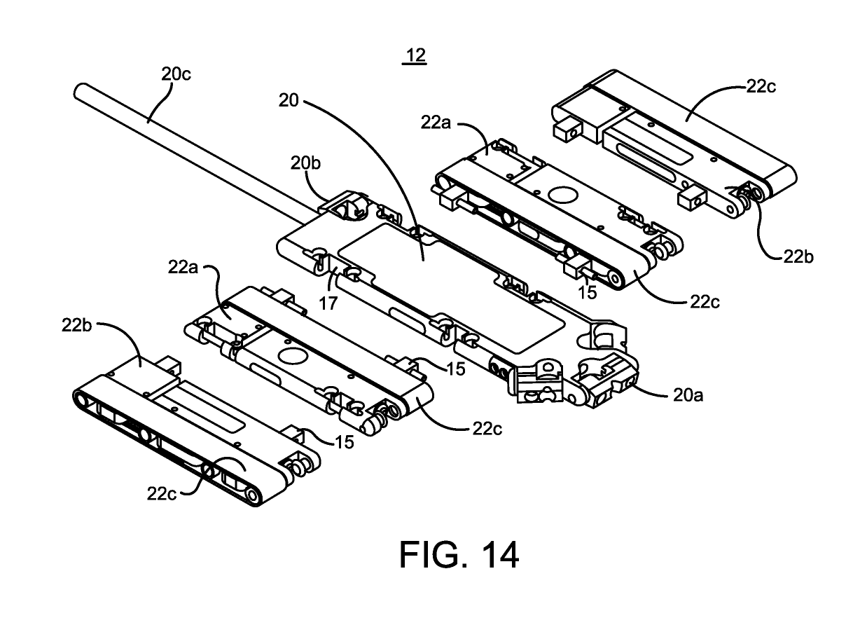

The crawler 12 crawls on the stator teeth 14a by magnetic attachment means such as the three magnets that are on each of the drive modules 22a and 22b as shown by FIGS. 12 and 13. The magnets are reference numeral 4 in FIG. 7 and reference numeral 3 in FIG. 3. The crawler 12 works when the rotor 16 is in place in machine 10 and also when the rotor 16 is not in place.

However, since normally only the stator teeth 14a, which the belt track 22c of each of drive modules 22a and 22b ride on, are made of ferric material, the tracks 22c have to be aligned, or at least substantially aligned, with the stator teeth 14a. Since the teeth dimension and the width ratio between the tooth 14a and wedge 14b vary across different motors/generators, the tracks 22c have to be adjustable to match the tooth configuration for a specific machine. As is well known, the wedges 14b shown in cross section in FIG. 2a keep the copper coils in machine 10 in place.

The installation device shown and described herein is used to deliver the modular air gap crawler 12 into the air gap of the motor/generator which the crawler operates on and to remove the crawler 12 from the air gap after it has finished its operations in the air gap. FIGS. 4a and 4b show a top view of one embodiment for the installation device 40. In both figures the installation device 40 has a metallic head 40a attached to a reconfigurable handle 40b. In FIG. 4a the crawler 12 is not mounted on device 40 whereas in FIG. 4b the crawler 12 is shown magnetically attached to metallic head 40a.

The head 40a of device 40 is made of a thin steel sheet on top of an aluminum sheet so that the magnetically attached crawler 12 as shown in the top view of FIG. 4b can be held securely on head 40a during the installation into and removal of crawler 12 from the air gap. The head 40a can be composed of other materials and layers. For example, there could be only one sheet of metal and that layer could be made of steel or some other ferromagnetic material.

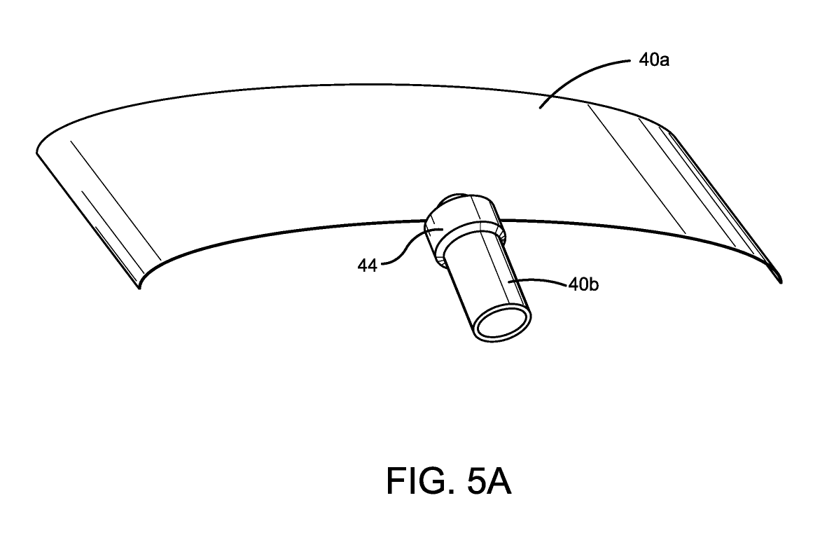

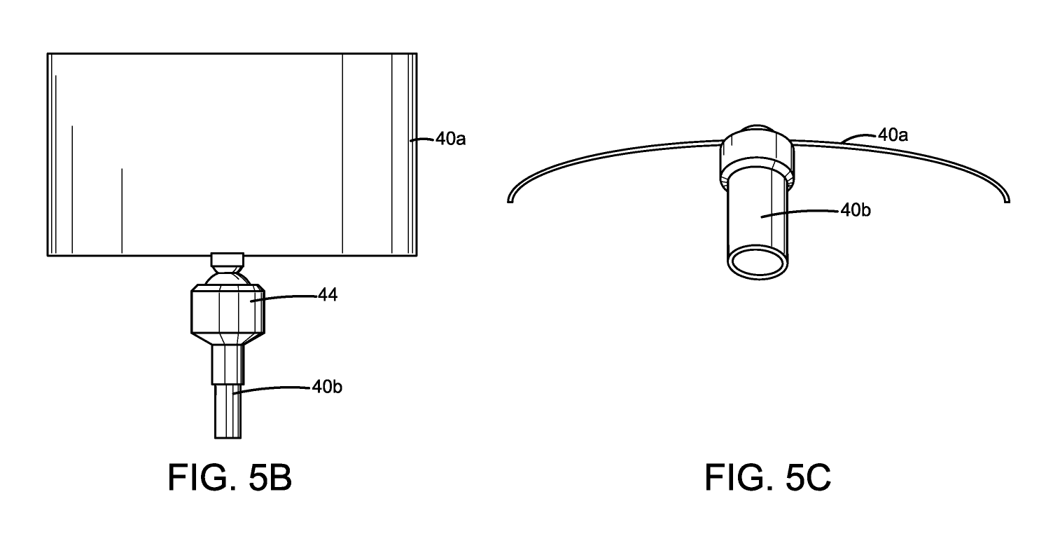

FIGS. 5a, 5b and 5c show respectively perspective, top and back views of head 40a attached to a handle 40b only a small part of which is shown in the figures. As shown in the perspective view in FIG. 5a of installation device 40 the metal sheets of head 40a can be “rolled” into the right curvature to fit the stator's inner surface. The curvature of the head 40a can be formed on site with a simple rolling tool. As can be appreciated, head 40a has to be thin enough not to add additional thickness to the thickness of crawler 12 that may prevent the installation of the crawler 12 into the air gap. The thinner and lighter the device 40 is will also make it more usable to the operator.

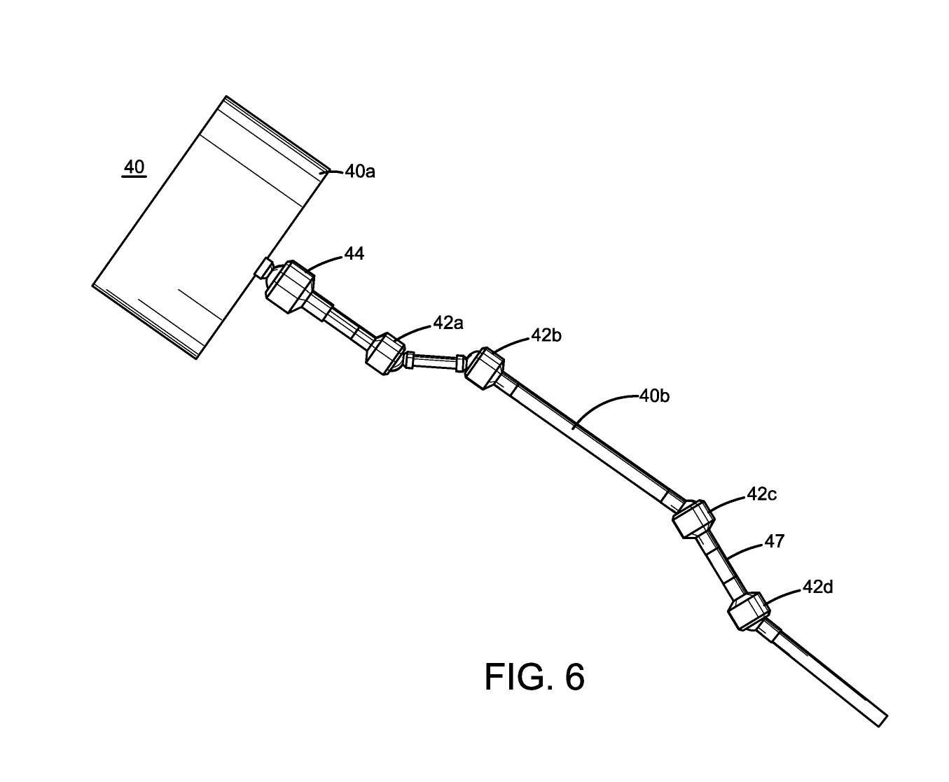

Head 40a is attached to a handle 40b one embodiment of which is shown in FIGS. 4a and 4b. As is described in more detail below, the handle 40b has reconfigurable joints. Two such joints 42a and 42b are shown in FIGS. 4a and 4b and a universal joint 44 at the end of the handle 40b where the head 40a is connected to the handle 40b. Other embodiments for the reconfigurable handle 40b of device 40 are shown in FIGS. 6, 7 and 8. FIG. 6 shows a handle 40b with four joints 42a, 42b, 42c and 42d, linkages 47 and a universal joint 44, FIG. 7 shows a straight bar with only one or two joints and FIG. 8 shows a handle 40b with three configurable revolute joints 46a, 46b and 46c and universal joints 44 at the end of the handle 40b where the head 40a is connected to the handle 40b. Thus the joints for the handle 40b and the head 40a can be all universal joints in the handle and for the head 40a as shown in FIG. 6 or a mi20 of revolute and universal joints as shown in FIG. 8 or other joints.

As can be appreciated the straight bar handle 40b with only one or two joints that connects the handle 40b with the head plate 40a as shown in FIG. 7 is for inserting a crawler 12 into relatively easily accessed air gaps. For these types of air gaps the straight bar handle 40b overcomes the distance obstacle in which the crawler 12 could not be placed by hand directly due to reachability limitations.

As also can be appreciated, the multiple joint reconfigurable handle 40b shown in FIGS. 6 and 8 can be used when there are more and complex obstacles at the air gap entry. As shown in FIG. 8, there is a quick locking 48 on each joint 46a, 46b and 46 c of the handle. When the handle 40b has been configured into the needed shape based on the particular obstacle shape and dimension the installation device 40 needs to deal with, the joints 46a, 46b and 46c are quickly locked in place. In field tests this reconfigurable handle 40b enhanced the usability of the crawler operation on variety different types of motor/generator. With the highly modular crawler design, on-site configurable tool set and the reconfigurable handle, the optimal goal of universal air gap inspection (and other operation) system can be achieved.

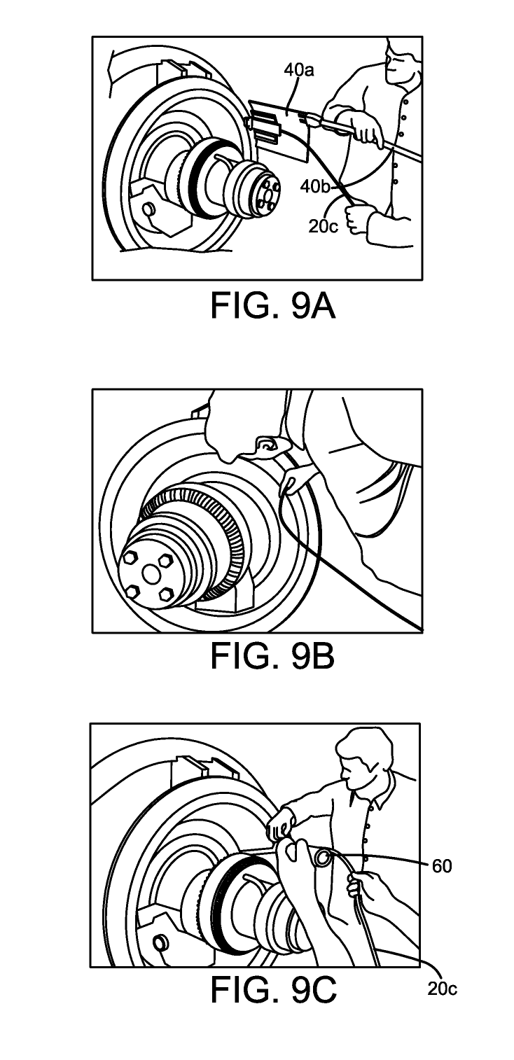

Referring now to FIGS. 9a, 9b and 9c there is shown photos in a lab test of using device 40 to install crawler 12 into the air gap of a rotating machine which in this example is a generator. As shown in FIG. 9a, the installation sometimes requires two persons. In such cases, one person uses the insertion device 40 to insert the crawler 12 into the air gap while other person supports the installation by holding the tether 20c of function module 20 and/or operating the joystick (not shown) that drives the crawler 12. FIG. 9a also shows the obstacle objects at the end of the generator after the generator end cover is removed to begin the installation. FIGS. 9b and 9c further show the installation process. In FIG. 9c the person holding the tether of module 20 is in the lab test also using a flashlight 60 to illuminate the air gap.

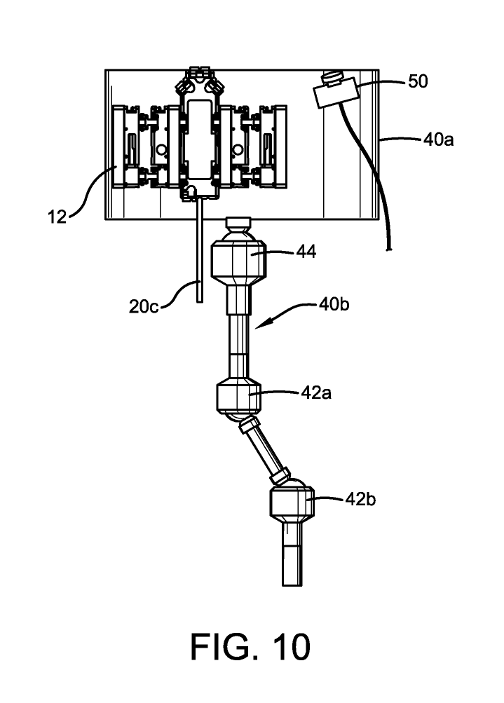

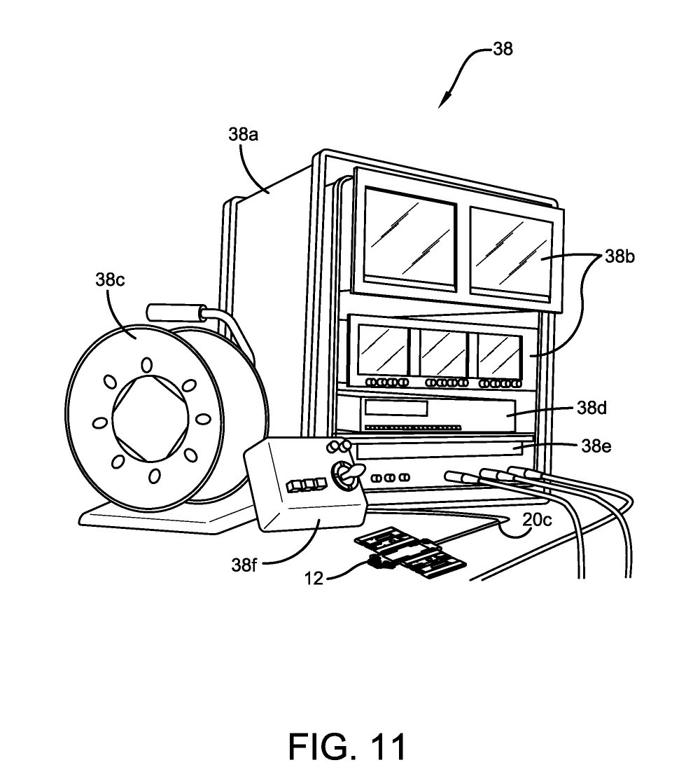

Referring now to FIG. 10, there is shown device 40 with crawler 12 magnetically attached to head 40a and a small camera 50 on head 40a. Camera 50 can be attached by a magnet so that the user can adjust its location to get the best view of the entrance of the air gap based on a given motor/generator's design. The camera 50 can (based on where it is located on the insertion head 40a) show the operator the interface between the crawler 12, insertion head 40a and the entrance to the air gap. The output of the camera 50 can be sent to a display, such as one of the monitors in the control cabinet N20 shown in FIG. 11 for crawler 12, to help the operator position the insertion device 40 and monitor the crawler's motion as it enters the air gap.

As is described above, when the insertion device 40 is used to retrieve the crawler 12 from an air gap the operator places the insertion device 40 at the opening of the air gap while the crawler 12 is already inside the air gap and then drives the crawler 12 onto the head 40a of the insertion device 40 and uses the insertion device 40 to remove the mounted crawler 12 from the air gap.

FIG. 14 shows an exploded perspective for one embodiment of the crawler 12. In this embodiment, the crawler 12 has a tethered function module 20 to which are attached function modules 22a and 22b. FIGS. 12 and 13 show exploded perspectives for the function modules 22a and 22b respectively.

It is to be understood that the description of the foregoing exemplary embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A vehicle delivery and retrieval device for inserting a remotely controlled vehicle in a confined space in a machine to inspect said confined space comprising:
a head dimensioned to fit in said confined space, said head fabricated to hold said vehicle without movement of said vehicle when said head with said vehicle mounted on said head is inserted in said confined space; and
a handle having one end attached to said head by a joint and two or more sections connected to each other by an associated joint.

2. The vehicle delivery and retrieval device of claim 1 wherein said head is fabricated from ferrous material and said vehicle has one or more magnets for gripping said head when said vehicle is placed on said head.

3. The vehicle delivery and retrieval device of claim 1 wherein said confined space is an air gap of a motor or generator, said air gap having a radius and said head is shaped to match said air gap radius.

4. The vehicle delivery and retrieval device of claim 1 wherein said machine is of a predetermined type and said confined space of said predetermined machine type has a radius and said head is shaped to match said radius.

5. The vehicle delivery and retrieval device of 4 wherein said machine is of a type that is different than said predetermined machine type, said different machine type having a confined space with a radius that is different than said radius of said predetermined machine confined space and said head can be reshaped to match said radius of said different machine type confined space.

6. The vehicle delivery and retrieval device of claim 1 having a camera mounted thereon to provide images to guide inserting said vehicle delivery and retrieval device with said vehicle on said head into said confined space.

7. The vehicle delivery and retrieval device of claim 6 wherein said vehicle mounted on said head is commanded to detach itself from said head when said vehicle delivery and retrieval device with said vehicle on said head is shown by images from said camera to be inserted in said confined space at a location where said vehicle can be detached from said head.

8. The vehicle delivery and retrieval device of claim 7 wherein said vehicle detached from said head in said confined space is commanded to move in said confined space and said camera provides images of said vehicle moving in said confined space.

9. A method for using a remotely controlled vehicle to inspect a confined space in a machine comprising:
mounting said vehicle on a head of a vehicle delivery and retrieval device, said head dimensioned for insertion in said confined space, said vehicle delivery and retrieval device having a handle having one end attached to said head by a joint and two or more sections connected to each other by an associated joint; and
inserting said vehicle delivery and retrieval device with said vehicle on said head in said confined space.

10. A vehicle delivery and retrieval device for inserting a remotely controlled vehicle in a confined space in a machine to inspect said confined space comprising:
a head dimensioned to fit in said confined space, said head fabricated to hold said vehicle without movement of said vehicle when said head with said vehicle mounted on said head is inserted in said confined space; and
a handle having one end attached to said head.

11. The vehicle delivery and retrieval device of claim 10 wherein said handle one end attached to said head has a joint for attaching said one end to said head.

12. The vehicle delivery and retrieval device of claim 10 wherein said handle has two or more sections connected to each other by an associated joint.
